(19) United States
(12) Patent Application Publication
(10) Pub. No.: US 2007/0053177 A1
(43) Pub. Date: Mar. 8, 2007

(54) Backlight assembly and liquid crystal display device having the same

(75) Inventors: Seong-Sik Choi, Seoul (KR); Du-Hwan Chung, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/516,018

(22) Filed: Sep. 5, 2006

(30) Foreign Application Priority Data
Sep. 5, 2005 (KR) 2005-82086

(51) Int. Cl. G09F 13/04

(52) U.S. Cl. 362/97

(57) ABSTRACT

A backlight assembly includes a receiving container, a lamp, a fixing member and a lamp holder. The lamp is disposed in the receiving container. The fixing member is disposed over the receiving container. The lamp holder has a hole into which the lamp is inserted, and a protruding portion supporting the fixing member. The protruding portion has a structure capable of making line contact or reduced surface contact with the fixing member. As a result, heat transfer from the lamp holder to the fixing member may be decreased to enhance display quality.

### CROSS-REFERENCE TO RELATED APPLICATION

This application relies for priority upon Korean Patent Application No. 2005-82086 filed on Sep. 5, 2005, the contents of which are herein incorporated by reference in their entirety.

### BACKGROUND OF THE INVENTION

1. Technical Field

The present disclosure relates to a backlight assembly and, more particularly, the to a backlight assembly having enhanced heat-dissipation properties, and a liquid crystal display device having the backlight assembly.

2. Discussion of the Related Art

A display device can transform electric signals processed by an information-processing device into an image.

A liquid crystal display (LCD) device, which is a type of display device, displays an image by using electric and optical properties of liquid crystal. An LCD panel does not emit light. In other words, an LCD panel is not self-emissive. Therefore, the LCD device may include a backlight assembly to display an image.

A conventional backlight assembly may be classified as a direct-illumination type backlight assembly or an edge-illumination type backlight assembly. With a direct-illumination type backlight assembly, a plurality of light sources is disposed under an LCD panel. With an edge-illumination type backlight assembly, a light source is disposed at a side of a light-guide plate, and light generated from the light source enters the light-guide plate through the side, and exits through an upper face of the light-guide plate to advance toward an LCD panel.

A fluorescent lamp may be employed as a light source of a backlight assembly. However, a fluorescent lamp generates a lot of heat. In order to prevent deterioration of display quality, which is caused by heat generated by the fluorescent lamp, research for dissipating heat generated from the fluorescent lamp has been performed.

According to a conventional backlight assembly, an LCD panel is disposed on a fixing member, and the fixing member is disposed on a lamp holder that holds a fluorescent lamp.

Heat generated from the lamp is dissipated through many elements, such as the lamp holder, the fixing member, and a receiving container.

Therefore, a portion of heat generated from the lamp is transferred to the LCD panel and may deteriorate the liquid crystal.

In particular, heat generated from electrodes disposed at end portions of the lamp is transferred to the LCD panel through the fixing member, thereby deteriorating display quality.

### SUMMARY OF THE INVENTION

Embodiments of the present invention provide a backlight assembly having enhanced heat-dissipation properties and a liquid crystal display (LCD) device having the backlight assembly.

A backlight assembly according to an embodiment of the present invention, includes a receiving container, a lamp, a fixing member and a lamp holder. The lamp is disposed in the receiving container. The fixing member is disposed over the receiving container. The lamp holder has a hole into which the lamp is inserted, and a protruding portion supporting the fixing member.

The lamp holder may also include a recessed bottom face such that an area of the bottom face is larger than a cross-sectional area that is substantially parallel with the bottom plate of the receiving container. A portion of the receiving container may have a shape that corresponds to the bottom face of the lamp holder such that the bottom face of the lamp holder makes contact with the portion of the receiving container.

The bottom face of the lamp holder may have an arch-shaped cross-section, a triangular wave-shaped cross-section, or a square wave-shaped cross-section.

A display device according to an exemplary embodiment of the present invention, includes a backlight assembly and an LCD panel. The backlight assembly generates light. The backlight assembly includes a receiving container, a lamp, a fixing member and a lamp holder. The lamp is disposed in the receiving container. The fixing member is disposed over the receiving container. The lamp holder has a hole into which the lamp is inserted, and a protruding portion supporting the fixing member. The LCD panel displays an image by using the light generated by the backlight assembly.

The protruding portion has a structure capable of making line contact or reduced surface contact with the fixing member. For example, the protruding portion has a prism shape, a parallelepiped shape, or a roof shape having an arch-shaped cross-section.

Furthermore, the protruding portion of a lamp holder may have a groove or a plurality of grooves and include a structure for making line contact or reduced surface contact between the lamp holder and the fixing member. The grooves may have various shapes.

Therefore, heat transfer from the lamp holder to the fixing member may be decreased and heat dissipation from a lower portion of the lamp holder may be increased, to enhance display quality.

### BRIEF DESCRIPTION OF THE DRAWINGS

Exemplary embodiments of the present invention can be understood in more detail from the following descriptions taken in conjunction with the accompanying drawings, in which:

FIG. 1 is an exploded perspective view illustrating a backlight assembly according to an exemplary embodiment of the present invention;

FIG. 2 is a perspective view illustrating a lamp holder in FIG. 1 according to an exemplary embodiment of the present invention;

FIG. 3 is a cross-sectional view taken along the line I-I′ in FIG. 1;

FIG. 4 is a perspective view illustrating a lamp holder according to an exemplary embodiment of the present invention;

FIG. 5 is an exploded perspective view illustrating a backlight assembly according to an exemplary embodiment of the present invention;

FIG. 6 is a perspective view illustrating a lamp holder in FIG. 5 according to an exemplary embodiment of the present invention;

FIG. 7 is a cross-sectional view taken along the line III-III′ in FIG. 5;

FIG. 8 is a perspective view illustrating a lamp holder according to an exemplary embodiment of the present invention;

FIG. 9 is an exploded perspective view illustrating a liquid crystal display (LCD) device according to an exemplary embodiment of the present invention;

FIG. 10 is a cross-sectional view taken along the line V-V′ in FIG. 9; and

FIGS. 11 to 13 are cross-sectional views illustrating LCD devices according to exemplary embodiments of the present invention.

### DETAILED DESCRIPTION OF THE EXEMPLARY EMBODIMENTS

Exemplary embodiments of the invention are described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

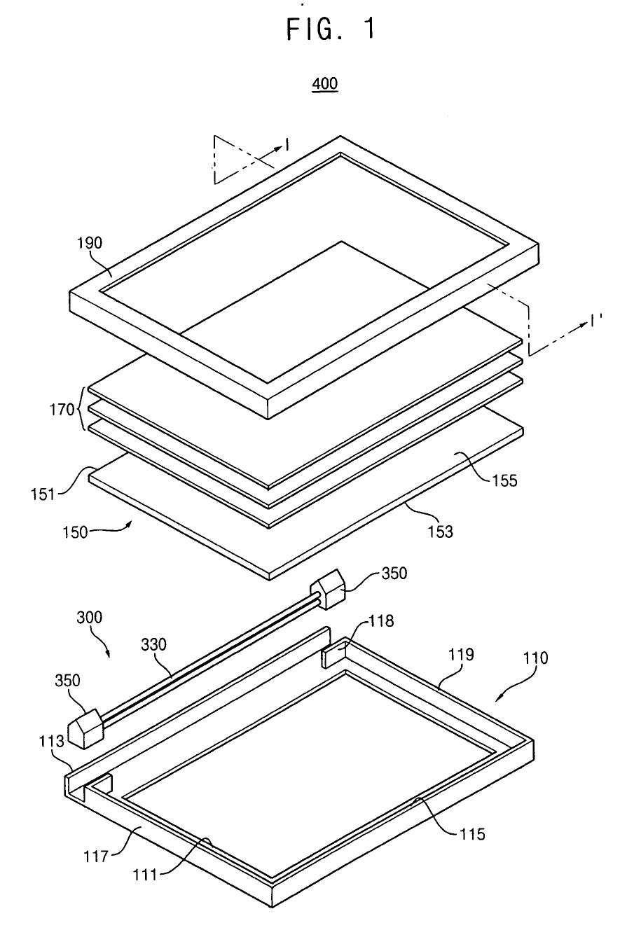

FIG. 1 is an exploded perspective view illustrating a backlight assembly according to an exemplary embodiment of the present invention.

Referring to FIG. 1, a backlight assembly 400 includes a receiving container 110, a light-guide plate 150, a lamp unit 300, a plurality of optical sheets 170 and a fixing member 190.

The receiving container 110 includes a bottom plate 111, a pair of first sidewalls 113 and 115, a pair of second sidewalls 117 and 119, and a light-guide plate fixing portion 118.

The bottom plate 111 has, for example, a rectangular shape. The bottom plate 111 supports the light-guide plate 150. The bottom plate 111 has an open portion in order to reduce weight.

The first sidewalls 113 and 115 are disposed at peripheral portions, for example, at edge portions of the bottom plate 11, to define a receiving space on the bottom plate 111.

The second sidewalls 117 and 119 are disposed on the bottom plate 111 such that the second sidewalls 117 and 119 are substantially perpendicular to the first sidewalls 113 and 115.

In order to define a space for receiving the lamp unit 300, the second sidewalls 117 and 119 are separated from the first sidewall 113.

For example, end portions of the second sidewalls 117 and 119 are cut and bent to define the space for receiving the lamp unit 300 and to form the light-guide plate fixing portion 118. The light-guide plate fixing portion 118 fixes the light-guide plate to prevent collision between the lamp unit 300 and the light-guide plate, so that damage to a lamp 330 of the lamp unit 300 is prevented.

The lamp unit 300 is disposed adjacent to the first sidewall 113 on the bottom plate 111. The lamp unit 300 includes the lamp 330 and a lamp holder 350. The lamp 330 has, for example, a long cylindrical shape, and the lamp holder 350 fixes an end portion of the lamp 330.

Alternatively, two lamp units 300 may be disposed adjacent to the first sidewalls 113 and 115, respectively.

The lamp 330 is transparent and has a tube shape. The lamp 330 includes discharge gas. When a discharge voltage is applied to electrodes disposed at respective end portions of the lamp 330, the discharge gas generates light.

The lamp holder 350 has a hole, and an end portion of the lamp 330 is inserted into the hole, so that the lamp holder 350 fixes the lamp 330. The lamp holder 350 is disposed between the first sidewall 113 and a light incident face 151 of the light-guide plate 150.

The lamp holder 350 protects the lamp 330, and fixes the lamp 330 in the receiving space adjacent the first sidewall 113.

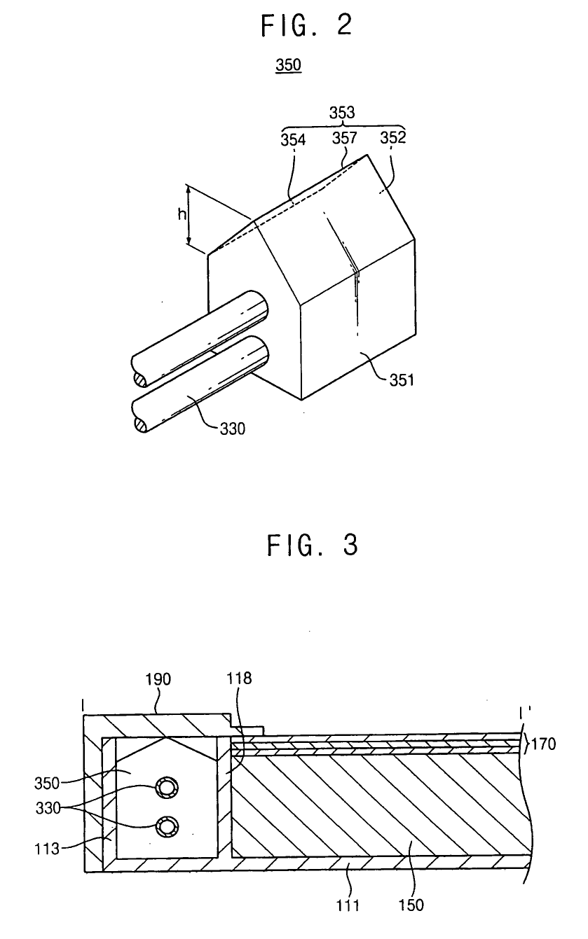

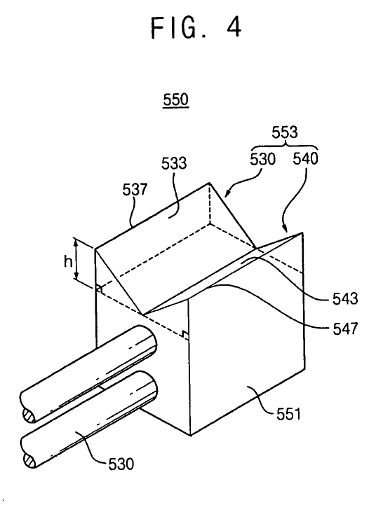

The lamp holder 350 has a protruding portion 353 as shown in FIGS. 2 and 3. The protruding portion 353 reduces a contact area between the lamp holder 350 and the fixing member 190 to reduce heat transferred from the lamp holder 350 to the fixing member 190.

The light-guide plate 150 receives light generated by the lamp 330 to upwardly transmit uniformized light.

The light-guide plate 150 has a plate-shape. The light-guide plate 150 is disposed on the bottom plate 111.

The light-guide plate 150 has the light incident face 151, a light reflecting face 153 and a light exiting face 155. The light incident face 151 faces the lamp unit 300 disposed along the first sidewall 113. The light reflecting face 153 is connected with a first end portion of the light incident face 151, and faces the bottom plate 111. The light exiting face 155 is connected with a second end portion of the light incident face 151, which is opposite to the first end portion. The light exiting face 155 is opposite to the light reflecting face 153.

At least one of the light exiting face 155 and the light reflecting face 153 may include a plurality of prism patterns to adjust light paths.

The optical sheets 170 are disposed over the light exiting face 155 of the light-guide plate 150, so that the optical sheets 170 receive light exiting from the light exiting face 155 to enhance optical characteristics such as luminance uniformity, and front-view luminance.

The fixing member 190 makes contact with the lamp holder 350, and is combined with the receiving container 110 to fix the light-guide plate 150 and the optical sheets 170.

FIG. 2 is a perspective view illustrating a lamp holder in FIG. 1.

Referring to FIG. 2, the lamp holder 350 has a lamp holder body 351 having a rectangular parallelepiped shape, and a protruding portion 353 protruding upward from the lamp holder body 351.

The protruding portion 353 has a prism shape having a first inclined face 352, a second inclined face 354 and an edge 357 where the first and second inclined faces 352 and 354 meet each other.

For example, a height ‘h’ of the protruding portion 353, which is defined as a vertical distance between a top of the holder body 351 and a top edge of the protruding portion 353, is in a range of about 0.1 mm to about 2.0 mm.

The lamp holder 350 includes flexible synthetic resins. For example, the lamp holder 350 includes silicone rubber.

The protruding portion 353 and the lamp holder body 351 may be integrally formed.

FIG. 3 is a cross-sectional view taken along the line I-I′ in FIG. 1.

Referring to FIG. 3, the lamp holder 350 is disposed at a region defined by the bottom plate 111 of the receiving container 110, the first side face 113, and the light-guide plate fixing portion 118.

The fixing member 190 is disposed over and combined with the receiving container 110.

The fixing member 190 makes contact with the edge 357 of the protruding portion 353 of the lamp holder 350.

In other words, the fixing member 190 makes line contact with the lamp holder 350 to minimize contact area between the fixing member 190 and the lamp holder 350. Therefore, heat transfer between the fixing member 190 and the lamp holder 350 may be minimized. A contact between an edge, where two faces (e.g., faces 352 and 354) meet each other, and a face of the fixing member 190 is referred to as “line contact”.

A distance between the lamp holder 350 and the fixing member 190 is increased by amount of the height ‘h’ to further reduce the heat transfer.

Hereinafter, another type of ‘line contact’ will be explained.

FIG. 4 is a perspective view illustrating a lamp holder according to an exemplary embodiment of the present invention.

A lamp holder 550 includes a lamp holder body 551 having a parallelepiped shape, and a protruding portion 553 disposed on a top portion of the lamp holder body 551.

The protruding portion 553 has two rectangular prisms 530 and 540. The two rectangular prisms 530 and 540 are disposed such that major faces 533 and 543 of the two rectangular prisms 530 and 540 are connected to each other and form a V-shape. In other words, the lamp holder 550 has a groove having a V-shaped cross-section.

For example, a height ‘h’ of the protruding portion 553, which is defined as a vertical distance between a top of the holder body 551 and a top of the protruding portion 553, is in a range of about 0.1 mm to about 2.0 mm.

Although not shown in FIG. 4, the fixing member 190 makes line contact with the two edges 537 and 547 of the two prisms 530 and 540.

Although two exemplary line contacts have been explained, the shape of the lamp holder is not limited to the examples. In alternative embodiments, the shape of the lamp holder may be changed while still making line contact with the fixing member 190.

For example, the major faces 533 and 543 may be rounded, such that the lamp holder may include a groove having a U-shaped cross-section. Furthermore, the lamp holder may have more than one groove.

In another alternative, the lamp holder may have a plurality of prism-shaped protrusions.

Furthermore, the lamp holder may have various protrusions or recesses formed at a surface that faces the fixing member 190.

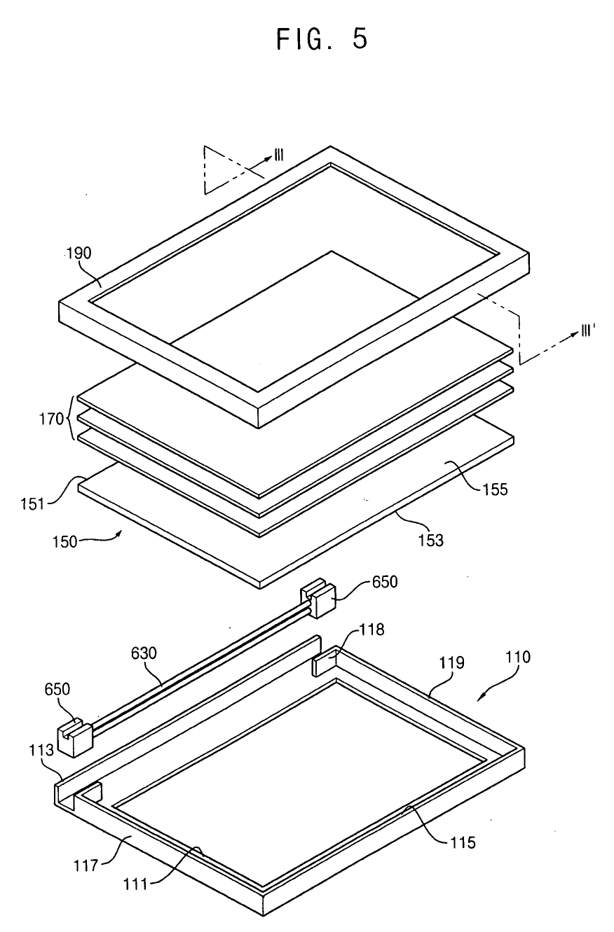

FIG. 5 is an exploded perspective view illustrating a backlight assembly according to an exemplary embodiment of the present invention.

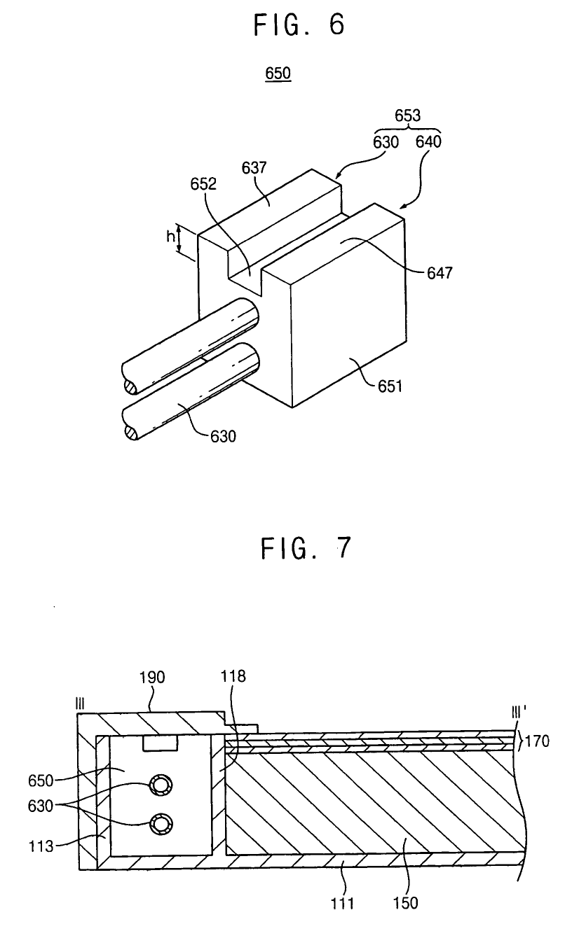

FIG. 6 is a perspective view illustrating a lamp holder in FIG. 5, and FIG. 7 is a cross-sectional view taken along the line III-III′ in FIG. 5.

The backlight assembly according to the embodiment described in connection with FIG. 5 is substantially the same as the backlight assembly in FIG. 1, except for a lamp holder. Referring to FIGS. 5, 6 and 7, a lamp holder 650 includes a lamp holder body 651 having a parallelepiped shape, and a protrusion 653 disposed at a top of the lamp holder body 651.

The protrusion 653 has, for example a first part 630 and a second part 640. Each of the first and second parts 630 and 640 has a rectangular parallelepiped shape. The first and second parts 630 and 640 are separated from each other. Therefore, a portion of the top face of the lamp holder body 651 is exposed between the first and second parts 630 and 640.

For example, a height ‘h’ of the protruding portion 653, which is defined as a vertical distance between a top of the holder body 651 and a top of the protruding portion 653, is in a range of about 0.1 mm to about 2.0 mm.

A first face 637 of the first part 630 and a second face 647 of the second part 640 reduce surface contact with the fixing member 190.

A contact between a face of the fixing member 190 and a surface of a lamp holder, wherein the surface of the lamp holder is smaller than the entire area of a top surface of the lamp holder body, is referred to as “reduced surface contact”.

A top face of the protruding portion 653, of which the area is smaller than that of a top face of the lamp holder 650, makes reduced surface contact with the fixing member 190, so that heat transfer from the lamp holder 650 to the fixing member 190 may be reduced.

Additionally, a distance between the lamp holder 650 and the fixing member 190 is increased by the height ‘h’ of the protruding portion 653, so that heat transfer may be further reduced.

Although the two parts 630 and 640 have a rectangular parallelepiped shape, and are separated from each other, any shape and any number of parts may be applicable to the lamp holder to create a contact area between the fixing member 190 and the lamp holder that is smaller than an area of a top face of the lamp holder body.

For example, polygonal column-shaped protrusions may be formed on the lamp holder body.

Hereinafter, another example of reduced surface contact will be explained.

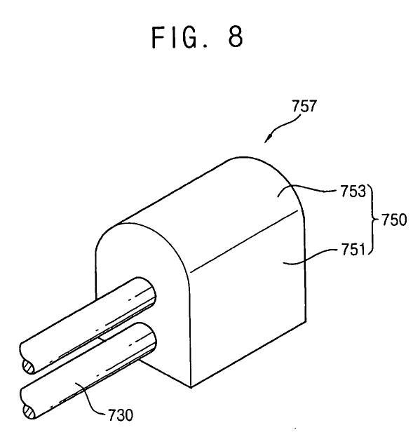

FIG. 8 is a perspective view illustrating a lamp holder according to an exemplary embodiment of the present invention.

A lamp holder 750 includes a lamp holder body 751 having a parallelepiped shape, and a protrusion portion 753 disposed on a top of the lamp holder body 751.

The protrusion portion 753 has a roof shape having an arch-shaped cross-section. As a result, the protrusion portion 753 has a rounded face 757.

As shown in FIG. 8, the rounded face 757 of the protrusion portion 753 makes reduced surface contact with the fixing member 190.

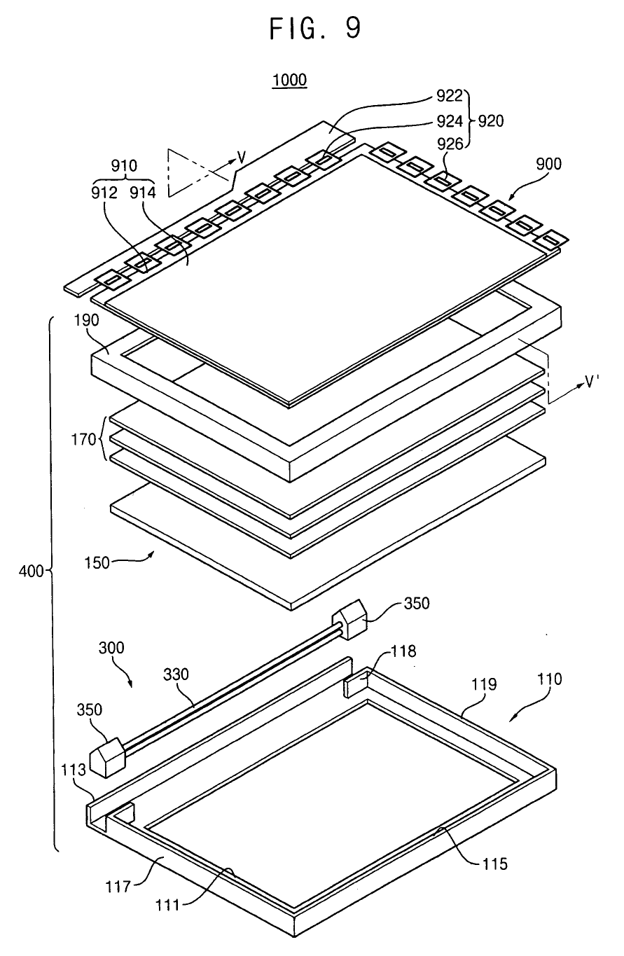

FIG. 9 is an exploded perspective view illustrating a liquid crystal display (LCD) device according to an exemplary embodiment of the present invention.

Referring to FIG. 9, an LCD device 1000 includes a backlight assembly 400 and a display unit 900.

The backlight assembly 400 may be any one of the above embodiments described in connection with FIGS. 1 to 8. The display unit 900 includes an LCD panel 910 displaying an image by using light provided by the backlight assembly 400, and a driver circuit section 920 driving the LCD panel 910.

The LCD panel 910 includes a first substrate 912, a second substrate 914 combined with the first substrate 912 such that second substrate 914 faces the first substrate 912, and a liquid crystal layer (not shown) interposed between the first and second substrates 912 and 914.

The first substrate 912 includes a plurality of thin-film transistors (TFTs) as switching devices formed thereon. The TFTs are arranged in a matrix shape. The first substrate 912 includes, for example, glass. Each of the TFTs includes a gate electrode electrically connected to one of gate lines, a source electrode that is electrically connected to one of source lines, and a drain electrode that is electrically connected to a pixel electrode. The pixel electrode includes an optically transparent and electrically conductive material.

The second substrate 914 includes red-green-blue (RGB) color filters formed thereon. The RGB color filters are arranged in a matrix shape. The second substrate 914 includes, for example, glass. The second substrate 914 further includes a common electrode having an optically transparent and electrically conductive material.

When a gate voltage is applied to the TFT through the gate line, the TFT is turned on to apply a data voltage to the pixel electrode. Then, electric fields are generated between the pixel electrode and the common electrode to change arrangement of liquid crystal molecules of the liquid crystal layer disposed between the pixel electrode and the common electrode. As a result, an optical transmittance of the liquid crystal layer is changed in the pixels to display an image.

The driver circuit section 920 includes a source printed circuit board (PCB) 922, a data flexible printed circuit (FPC) 924 and a gate FPC 926. The source PCB 922 provides the LCD panel 910 with data driving signals and gate driving signals. The data FPC 924 connects the source PCB 922 to the LCD panel 910. The gate FPC 926 is electrically connected to the gate line of the LCD panel 910.

The data FPC 924 and the gate FPC 926 may be embodied through a tape carrier package (TCP) or a chip-on-film (COF). The data driving signals generated by the source PCB 922 are applied to the data lines of the LCD panel 910 through the data FPCs 924, and the gate driving signals are applied to the gate lines of the LCD panel 910 through gate FPCs 926. The LCD panel 910 may further include signal lines (not shown) transferring the gate driving signals from the source PCB 922 to the gate FPCs 926.

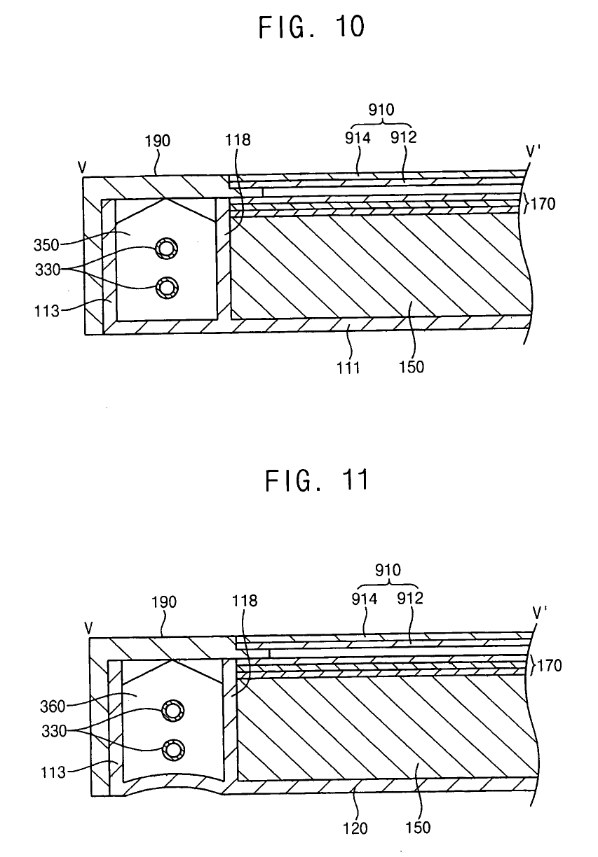

FIG. 10 is a cross-sectional view taken along the line V-V′ in FIG. 9.

Referring to FIG. 10, the fixing member 190 is disposed on the lamp holder 350, and the LCD panel 910 is disposed on the fixing member 190. Therefore, the lamp holder 350 makes contact with the fixing member 190, and the fixing member 190 makes contact with the LCD panel 910.

The lamp holder 350 makes line contact with the fixing member 190, so that heat transfer from the lamp holder 350 to the fixing member 190 may be minimized. As a result, deterioration of liquid crystal may be reduced, so that display quality may be enhanced.

FIGS. 11 to 13 are cross-sectional views illustrating LCD devices according to exemplary embodiments of the present invention.

The LCD devices according to embodiments described in connection with FIGS. 11-13 are substantially the same as the LCD device in FIG. 10, except for a lamp holder and a receiving container.

Referring to FIG. 11, in order to increase a surface area of a lower face of the lamp holder 360, the lower face of the lamp holder 360 has a concave shape. Additionally, a portion of the receiving container 120, where the lamp holder 360 is disposed, is formed such that the portion of the receiving container 120 makes contact with the lower face of the lamp holder 360. In other words, the portion of the receiving container 120, where the lamp holder 360 is disposed, has an arch-shaped cross-section.

Therefore, an area of the portion of the receiving container 120, where the lamp holder 360 is disposed, is increased to increase the area that is exposed to air. As a result, dissipation of the heat of the lamp holder 360 may be facilitated.

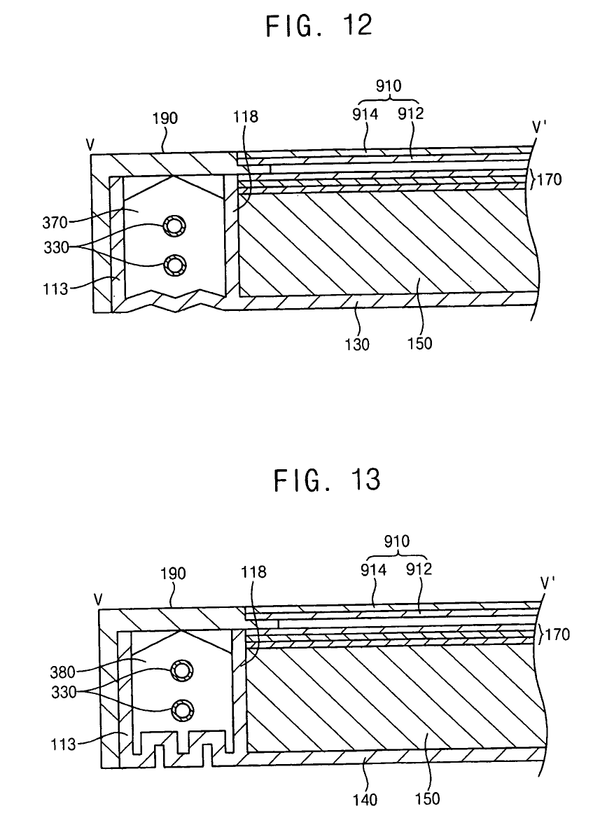

Referring to FIG. 12, in order to increase a surface area of a lower face of the lamp holder 370, the lamp holder 370 has a zigzag-shaped (or triangular wave-shaped) cross-section. Additionally, a portion of the receiving container 130, where the lamp holder 370 is disposed, is formed such that the portion of the receiving container 130 makes contact with the lower face of the lamp holder 370. In other words, the portion of the receiving container 130, where the lamp holder 370 is disposed, has a zigzag-shaped (or triangular wave-shaped) cross-section.

Therefore, an area of the portion of the receiving container 130, where the lamp holder 370 is disposed, is increased to increase the area that is exposed to air. As a result, dissipation of heat of the lamp holder 370 may be facilitated.

Referring to FIG. 13, in order to increase a surface area of a lower face of the lamp holder 380, the lamp holder 380 has a square wave-shaped cross-section. Additionally, a portion of the receiving container 140, where the lamp holder 380 is disposed, is formed such that the portion of the receiving container 140 makes contact with the lower face of the lamp holder 380. In other words, the portion of the receiving container 140, where the lamp holder 380 is disposed, has a square wave-shaped cross-section.

Therefore, an area of the portion of the receiving container 140, where the lamp holder 380 is disposed, is increased to increase the area that is exposed to air. As a result, dissipation of heat of the lamp holder 380 may be facilitated.

The bottom shapes of the lamp holder and the receiving container are not limited to FIGS. 11 to 13. Alternative shapes may be used to increase the area of a lower face of a lamp holder.

Furthermore, any combination of structures of the lamp holders in FIGS. 1 to 10, which are capable of reducing heat transfer from the lamp holder to the fixing member, with those of the lamp holders in FIGS. 11 to 13, which are capable of enhancing heat dissipation of the lamp holder, may be used.

According to the exemplary embodiments of the present invention, the lamp holder includes a protruding portion that makes line contact or reduced surface contact with the fixing member.

Therefore, heat transfer from the lamp holder to the fixing member, which makes contact with the LCD panel, may be reduced to enhance display quality.

Furthermore, the lamp holder and the receiving container can have a structure for increasing a bottom surface area, so that heat dissipation may be increased to further enhance display quality.

Having described the exemplary embodiments of the present invention, it is noted that various changes, substitutions and alterations can be made herein without departing from the spirit and scope of the invention as defined by appended claims.

What is claimed is:

1. A backlight assembly comprising:
a receiving container;
a lamp disposed in the receiving container;
a fixing member disposed over the receiving container; and
a lamp holder having a hole into which the lamp is inserted, and a protruding portion supporting the fixing member.

2. The backlight assembly of claim 1, wherein the lamp holder makes line contact with the fixing member.

3. The backlight assembly of claim 2, wherein the protruding portion has a prism shape.

4. The backlight assembly of claim 1, wherein the protruding portion makes reduced surface contact with the fixing member.

5. The backlight assembly of claim 4, wherein the protruding portion has a parallelepiped shape.

6. The backlight assembly of claim 4, wherein the protruding portion has an arch-shaped cross-section.

7. The backlight assembly of claim 1, wherein the protruding portion has a height ranging from about 0.1 mm to about 2.0 mm.

8. The backlight assembly of claim 1, wherein the fixing member has a frame shape.

9. The backlight assembly of claim 1, further comprising a light-guide plate, wherein the lamp is disposed at a side of the light-guide plate.

10. The backlight assembly of claim 9, further comprising an optical sheet disposed over the light-guide plate.

11. A backlight assembly comprising:
a receiving container having a bottom plate;
a lamp disposed in the receiving container;
a fixing member disposed over the receiving container; and
a lamp holder having a hole into which the lamp is inserted, the lamp holder having a recessed bottom face, wherein a portion of the receiving container has a shape that corresponds to the bottom face of the lamp holder, whereby the bottom face of the lamp holder contacts the portion of the receiving container.

12. The backlight assembly of claim 11, wherein the bottom face of the lamp holder has an arch-shaped cross-section.

13. The backlight assembly of claim 11, wherein the bottom face of the lamp holder has a triangular wave-shaped cross-section.

14. The backlight assembly of claim 11, wherein the bottom face of the lamp holder has a square wave-shaped cross-section.

15. A liquid crystal display (LCD) device comprising:
a backlight assembly generating light, the backlight assembly comprising:
a receiving container;
a lamp disposed in the receiving container;
a fixing member disposed over the receiving container; and
a lamp holder having a hole into which the lamp is inserted, the lamp holder making line contact with the fixing member; and
an LCD panel displaying an image by using the light generated by the backlight assembly.

16. The LCD device of claim 15, wherein the lamp holder has at least one prism shape making line contact with the fixing member.

17. The LCD device of claim 15, wherein the lamp holder has a groove formed in a region facing the fixing member.

18. A liquid crystal display (LCD) device comprising:
a backlight assembly generating light, the backlight assembly comprising:
a receiving container;
a lamp disposed in the receiving container;
a fixing member disposed over the receiving container; and
a lamp holder having a hole into which the lamp is inserted, the lamp holder making reduced surface contact with the fixing member; and
an LCD panel displaying an image by using the light generated by the backlight assembly.

19. The LCD device of claim 18, wherein the lamp holder has at least one parallelepiped shape making reduced surface contact with the fixing member.

20. The LCD device of claim 18, wherein the lamp holder further comprises a protruding portion making the reduced surface contact, and the protruding portion has an arch-shaped cross-section.

21. A liquid crystal display (LCD) device comprising:
a backlight assembly generating light, the backlight assembly comprising:
a receiving container having a bottom plate;
a lamp disposed in the receiving container;
a fixing member disposed over the receiving container; and
a lamp holder having a hole into which the lamp is inserted, and a protruding portion supporting the fixing member; and
an LCD panel displaying an image by using the light generated by the backlight assembly.

22. The LCD device of claim 21, wherein the protruding portion of the lamp holder is formed at a surface of a lamp holder body, which faces the fixing member.

23. The LCD device of claim 21, wherein the protruding portion has a prism shape or a parallelepiped shape.

24. The LCD device of claim 21, wherein the lamp holder has a recessed bottom face, and a portion of the receiving container has a shape that corresponds to the bottom face of the lamp holder, whereby the bottom face of the lamp holder contacts the portion of the receiving container.

25. The backlight assembly of claim 24, wherein the bottom face of the lamp holder has an arch-shaped cross-section.

26. The backlight assembly of claim 24, wherein the bottom face of the lamp holder has a triangular wave-shaped cross-section.

27. The backlight assembly of claim 24, wherein the bottom face of the lamp holder has a square wave-shaped cross-section.
